(19) United States
(12) Patent Application Publication
(10) Pub. No.: US 2026/0298845 A1
(43) Pub. Date: Oct. 1, 2026

(54) TOMOGRAPHIC IMAGING SYSTEM GEOMETRY TO MITIGATE ARTIFACTS

(71) Applicant: Baker Hughes Holdings LLC, Houston, TX (US)

(72) Inventors: David Uribe Gallo, Augsburg (DE); Tobias Neubrand, Hannover (DE); Christoph Seitz, Neustadt (DE)

(21) Appl. No.: 19/089,873

(22) Filed: Mar. 25, 2025

(51) Int. Cl. G01N 23/046

(52) U.S. Cl. CPC G01N 23/046; G01N 2223/079; G01N 2223/1016; G01N 2223/308; G01N 2223/309; G01N 2223/32

(57) ABSTRACT

A tomographic imaging system includes a detector configured to receive X-ray beams and an X-ray source arranged and configured to emit both a primary X-ray beam and a secondary X-ray beam towards the detector. The system further includes an object support holding an object between the X-ray source and the detector, and an actuator coupled to the object support. The actuator is configured to offset the object relative to a principal axis of the X-ray source by a distance determined based on an X-ray source-to-detector distance, such that the secondary X-ray beam is directed away from the detector while the primary X-ray beam is aligned with an object to be imaged between the detector and the X-ray source.

### TECHNICAL FIELD

The subject matter described herein relates to the X-ray imaging technology.

### BACKGROUND

One of the persistent challenges in X-ray imaging applications is the degradation of image quality due to backscattering electrons in X-ray sources which create a second X-ray signal (secondary X-ray source). The secondary source detected alongside the primary radiation that travels directly from the source's target to the detector. The presence of this scattered radiation in the detected signal results in images that are often blurred or obscured, reducing the clarity and contrast necessary for accurate analysis and interpretation. Conventional X-ray imaging system often requires the integration of physical barriers such as grids or collimators that block secondary rays from reaching the detector, which complicate the imaging setup and reduces the overall intensity of the detected signal.

### SUMMARY

This disclosure relates to the tomographic imaging system geometry to mitigate artifacts.

An example implementation of the subject matter described herein is a tomographic imaging system that includes a detector and an X-ray source. The X-ray source emits both a primary X-ray beam and a secondary X-ray beam towards the detector, and the detector is capable of receiving and detecting both the primary X-ray beam and the secondary X-ray beam. The tomographic imaging system also includes an object support. The object support is configured to hold an object to be imaged between the detector and the X-ray source. The tomographic imaging system further includes an actuator coupled to the object support. The actuator offsets the object relative to a principal axis of the X-ray source by a distance. In some implementations, the actuator can include a motorized linear actuator. The distance is determined based on a distance between the X-ray source and the detector. The offset distance ensures that the secondary X-ray beam is directed away from the object, while the primary X-ray beam remains focused on the object.

In some implementations, the X-ray source can include an electrical X-ray tube. In such implementations, the electrical X-ray tube includes an anode and a cathode enclosed within a vacuum chamber. The cathode is configured to emit electrons towards the anode, which causes the anode to emit the primary X-ray beam. A secondary X-ray beam can be emitted as a result of the electrons backscattering from the anode towards the cathode within the vacuum chamber. In some implementations, the primary X-ray beam is characterized by a cone beam geometry with a divergent spread between the detector and the X-ray source. In some implementations, the secondary X-ray beam is characterized by a cylindrical geometry between the detector and the X-ray source. In some implementations, the secondary X-ray beam has a diameter of approximately 20 mm. In some implementations, the electrical X-ray tube operates with an electron beam energy ranging from 40 keV to 9000 keV.

An example of the subject matter described herein includes a method to mitigate artifacts. In operation, an object to be imaged is held between an X-ray source and a detector using an object support. A primary X-ray beam is emitted from the X-ray source towards the detector. A secondary X-ray beam is emitted from the X-ray source towards the detector. The object is translated relative to the detector using the actuator by an offset distance. The offset distance is determined based on a distance between the X-ray source and the detector. The offset distance ensures that the primary X-ray beam intersect with the object and the secondary X-ray beam avoids the object.

In some implementations, the secondary X-ray beam can have a diameter of approximately 20 mm. The data characterizing a position of the detector can be received using a control unit. In some implementations, the control unit is operably connected to the detector, the X-ray source, and the actuator. The offset distance can then be adjusted based on a change in the position of the detector. The data characterizing an intensity of the secondary X-ray beam is also received. The offset distance can then be adjusted based on a change in the intensity of the secondary X-ray beam.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations.

FIGS. 1A-1C are schematic diagrams of an example tomographic imaging system.

FIG. 2 is an example X-ray scan obtained by the tomographic imaging system as described in FIG. 1A.

FIG. 3 is an example X-ray scan obtained by the tomographic imaging system as described in FIG. 1C.

FIG. 4 is a block diagram of an example controller that can be used with aspects of this disclosure.

FIG. 5 is a flowchart of an example method that can be used with aspects of this disclosure.

### DETAILED DESCRIPTION

Certain implementations will now be described to provide an overall understanding of the principles of the structure, function, manufacture, and use of the devices and methods disclosed herein. One or more examples of these implementations are illustrated in the accompanying drawings. Those skilled in the art will understand that the devices and methods specifically described herein and illustrated in the accompanying drawings are non-limiting implementations and that the scope of the present invention is defined solely by the claims. The features illustrated or described in connection with one implementation may be combined with the features of other implementations. Such modifications and variations are intended to be included within the scope of the present invention.

Further, in the present disclosure, like-named components of the implementations generally have similar features, and thus within a particular implementation each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

Conventional tomographic imaging system often encounter challenges related to unwanted secondary radiation that can degrade image quality. Traditionally, mitigating these effects involves in-device shielding (e.g., grids or collimators that block scattered beams from reaching the detector) or post-processing techniques. The system and method described herein addresses the issue where the X-ray source is dynamically rotated such that the secondary X-ray beam is directed away from the detector while ensuring the primary X-ray beam remains aligned with the object to be imaged.

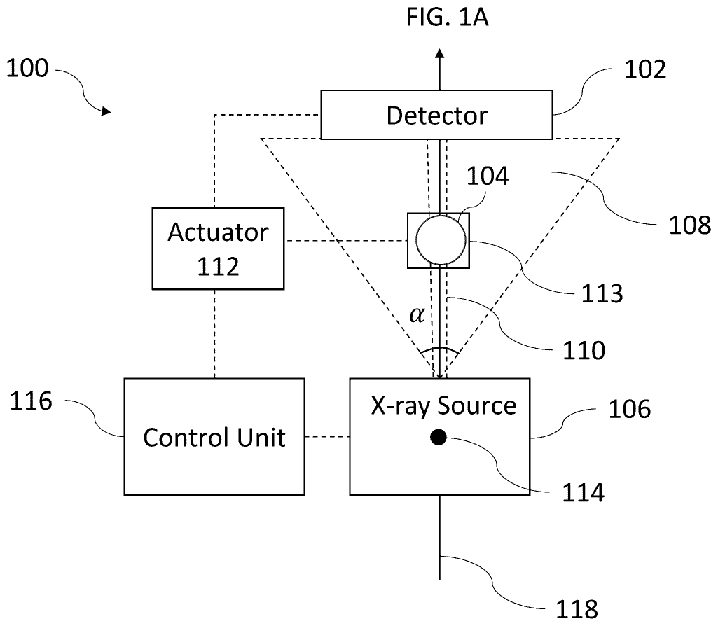

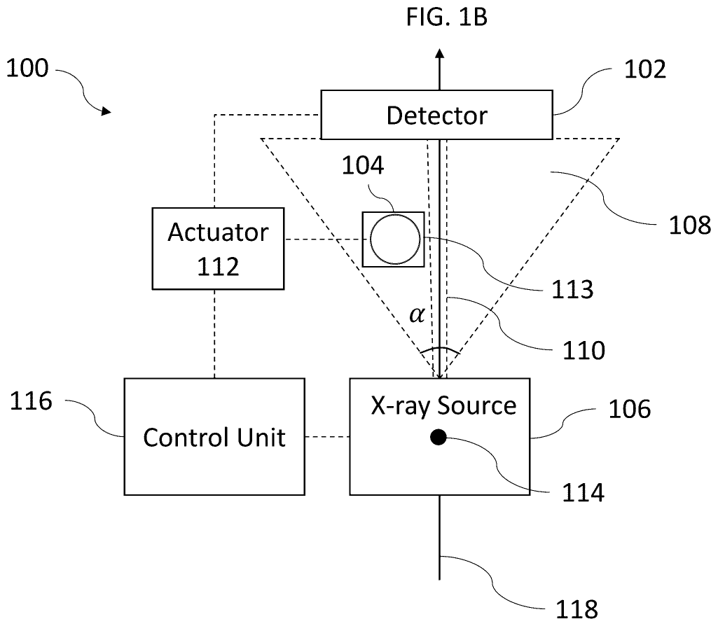

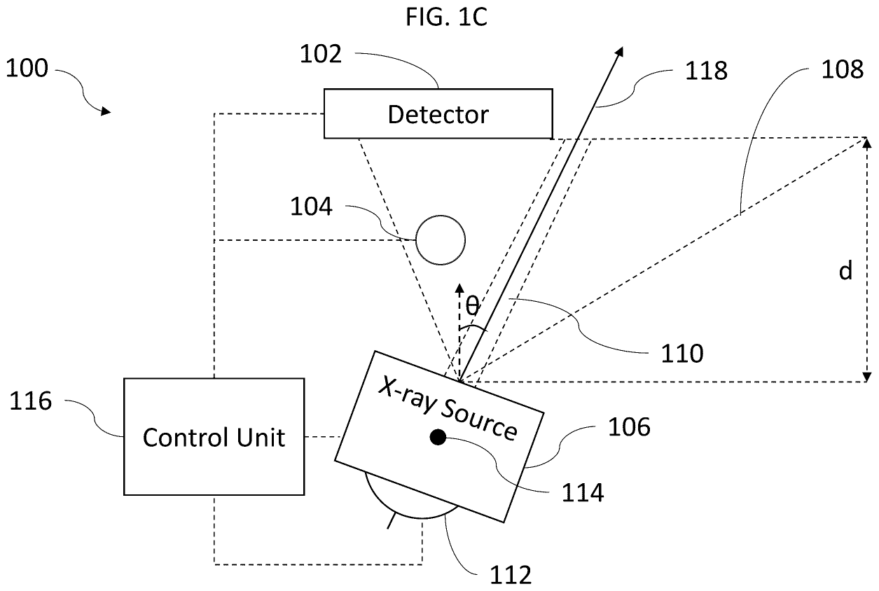

FIG. 1A illustrates an example implementation of a tomographic imaging system 100. The tomographic imaging system includes an X-ray detector 102 for capturing the X-rays after they have passed through an object 104 being imaged. The tomographic imaging system 100 also includes an X-ray source 106 configured to emit both a primary X-ray beam 108 and a secondary X-ray beam 110. The primary X-ray beam 108 is intended for imaging, while the secondary X-ray beam 110, as described herein, can be arranged to avoid the X-ray detector 102. The tomographic imaging system 100 further include an actuator 112 coupled to an object support 113 holding the object 104. The actuator can translate (or rotate) the object holder thereby offset the object relative to a principal axis 114 by certain distance. This offset distance is determined based on the X-ray source-to-detector distance to ensure that the secondary X-ray beam 110 does not intersect with the X-ray detector 102.

The detector 102 is configured to convert received X-ray beams into measurable electrical signals that can be processed, for example, by a control unit 116 operably connected to the detector 102 as described throughout this disclosure, to form one or more images. It should be noted that, within the field of tomographic imaging, terms such as “projections” and “scans” can be used interchangeably with “images” throughout this disclosure. In some implementation, the detector 102 includes scintillators configured to detect the energy of incoming X-ray beams and re-emit the energy as visible light. In some implementation, the detector 102 includes one or more photodiodes or charge-coupled devices (CCDs) configured to detect visible light emit by the scintillator. Alternatively, or in addition, the detector 102 is composed of direct conversion materials, such as amorphous selenium. In this example, the detector can convert X-ray photons directly into an electrical charge without the intermediate step of light production.

The X-ray source 106, in some implementation, can be an X-ray tube. The X-ray tube includes an anode and a cathode enclosed in a vacuum environment (e.g., a glass or metal enclosure). The vacuum environment ensures the efficient propagation of electrons from the cathode to the anode without interference from air molecules. In some cases, the X-ray tube can be an electrical X-ray tube where the cathode is heated to emit electrons through thermionic emission. These electrons are then accelerated toward the anode by an electric field between the cathode and the anode. Upon striking the anode, the kinetic energy of the electrons is transformed into X-ray beams. In some implementation, the electrical X-ray tube is configured to operate with an electron beam energy ranging from 40 keV to 9000 keV.

In some implementation, a focusing cup can be placed around the cathode and is configured to focus the emitted electrons into a narrow channel configured as a focusing lens. The lens further narrows the electron beam and direct electrons towards the anode into a small area of the material. This highly focused electron beam creates a significant amount of heat in the target. In some implementations, anode may be a rotating anode which, in some cases, help dissipate heat more effectively compared to a stationary anode, allowing for higher intensity and longer imaging sessions without damaging the anode. For this configuration, the anode is manufactured with highly heat-conductive and heat-resistant materials that removes the heat away from the focused target area without requiring moving targets.

The collision of electrons with the anode results in the generation of the primary X-ray beam 108. More precisely, the anode's atomic structure changes electron's path via Bremsstrahlung, elastic and inelastic collisions. Ultimately, such path deviations generate the primary X-ray beam 108. In some implementations, the anode can be made of or include tungsten. Regardless, such collision generates X-rays that diverge from a focal spot on the anode. However, not all electrons contribute to the primary X-ray beam 108. When electrons from the cathode strike the anode, not all energy is transferred into X-ray production. Although the electron beam is highly focused, a portion of the electrons still can be emitted from the cathode in random directions. Some electrons are backscattered towards the cathode or other tube parts. These backscattered electrons can then interact with other components within the vacuum chamber of the X-ray tube, generating the secondary X-ray beam 110.

In some implementation, the secondary X-ray beam 110 has a diameter of approximately 20 mm. A larger diameter results in a larger image artifact. As shown in FIG. 1A, the primary X-ray beams 106 can cover a larger area of the object 104 compared to the secondary X-ray beams 110 as it propagates toward the detector. This is because the secondary X-ray beam 110 is produced by backscattered electrons that have random interactions within the tube's inner cylindrical shape (aligned with an optical axis 118), back toward the cathode, whereas the primary X-ray beam 108 is produced by a small area in the anode (focal spot) right at the tube's end and is the generatrix of the cone beam geometry. In the illustrated example, the primary X-ray beam 108 has a spread cone shape with α>170°, while the second X-ray beam 110 can have cylindrical shape of diameter 20 mm. The X-ray beams are subsequently received and absorbed by the detector 102 such that a corresponding scan can be provided.

For example, as shown in FIG. 1A, X-ray source 106 can emit X-ray beams in a cone shape (or a fan shape) to which at least a portion of the object 104 is exposed. The secondary X-ray beam 110 has a cylindrical shape. The cone shape defines the spatial distribution of the X-ray radiation with a narrower focus at the origin (e.g., the output port of the X-ray tube 106) that gradually widens as it extends away from the X-ray source 106. While the secondary X-ray beam 110 is predominantly parallel. In some cases, the orientation and intensity of the secondary X-ray beam 110 is influenced by the angle of electron backscatter within the X-ray tube and the specific material used for the anode. For example, materials with higher atomic numbers tend to produce more pronounced backscatter, leading to a more intense secondary beam. Additionally, the operational voltage and current settings of the X-ray tube can affect the energy profile of the secondary beam 110.

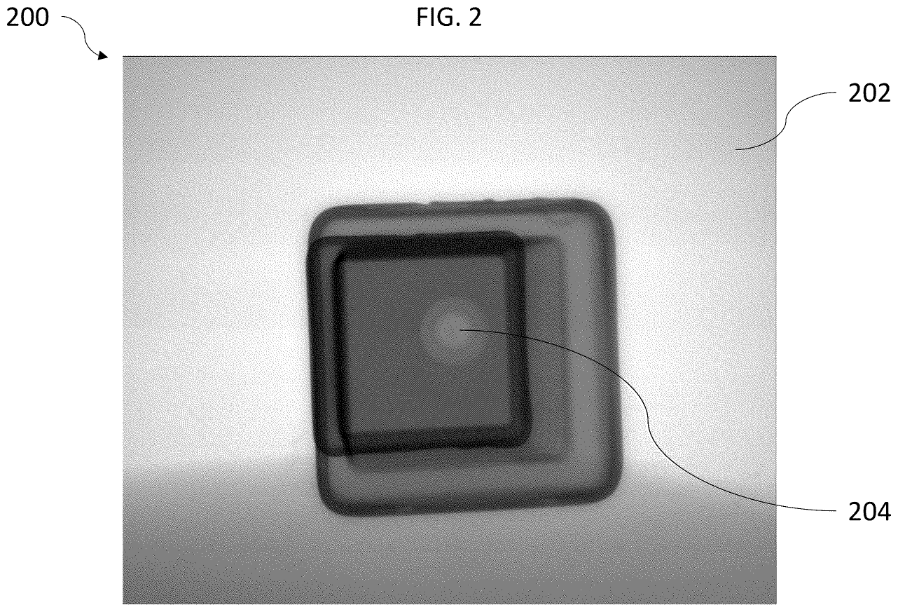

In some implementation, the secondary X-ray beam 110 can be captured as a less defined mark, for example, in a broad, diffuse, circular pattern, as illustrated in FIG. 2. FIG. 2 is an example of an X-ray scan 200 obtained by the system and method as described herein, prior to the rotation of the X-ray source 106. The secondary beam 110 is less defined than the sharp focus provided by the primary radiation image. The X-ray scan 200 is an example diagnostic projection, where both the desired primary signal 202 and the undesired secondary beam 110 are detected. As illustrated in FIG. 2, sharp details of a capacitor are provided by the X-ray scan 200. However, the image artifact 204, provided by the secondary beam 110 appears in proximity to a center of the primary projection 200 as a circular, diffuse haze that blurs and obscure the details of at least a portion of the object. This is because the object is penetrated by both primary and secondary radiation sources and therefore appear in the same projection.

In some implementation, the X-ray source 106 is positioned directly across from the detector 102, with the object 104 located between them. The detector 102 is positioned at a distance from the X-ray source based on the desired filed of view and the specific imaging requirements. The object 104 is supported by an object support 113, such as a platform or a holder in which its position can be adjusted within the X-ray beams'path. The object support 113 is mechanically coupled to the actuator 112. In some implementations, as shown in FIG. 1B, the actuator 112 is configured to dynamically adjust a position of the object 104 relative to the optical axis 118 (or optical axis 118) while the X-ray source 106 and the detector 102 remain static so that the object 104 is positioned to offset the secondary X-ray beam 110 to reduce or eliminate its impact on the object 104. The principal axis 114 typically aligns perpendicular with the central line (e.g., the longitudinal axis) of emission from the X-ray source 106. In this example, the actuator can be a motorized linear actuator including components such as motors, gears, and electronic controls that provides fine-tuned translational movements of the object support 113.

Additionally or alternatively, the position of the X-ray source 106 can also be adjusted. For example, as shown in FIG. 1C, instead of adjusting the position of the object 104, the X-ray source 106 can be adjusted such that the primary X-ray beam 108 intersects with the detector 102 after passing through the object 104. Simultaneously, the secondary X-ray beam 110 is directed away from the detector 102 such that the optical axis 118 no longer intersects with the detector 102. For example, the actuator 113 can be mechanically coupled to the X-ray source 106 and is configured to rotate the X-ray source 105. As shown in FIG. 1C, rotated X-ray source 105 includes a newly oriented optical axis 118 which now points past the detector 102 or beyond. This reduces or eliminates the exposure of the detector to secondary radiation 110, reducing or eliminating noise and improving the clarity and contrast of the captured images. The angular adjustment θ of the X-ray source 106 relative to the optical axis 118 increases as the source-to-detector distance d decreases. The source-to-detector distance d can affect the divergence and focal point of the X-ray beams. For example, a larger source-to-detector distance typical requires a smaller angular adjustment θ to achieve the same effect of directing the secondary X-ray beam 108 away from the detector 102 as compared to a shorter distance, where a greater angular adjustment is necessary to ensure that the secondary X-ray beam 108 misses the detector 102. This is due to the geometric properties of X-ray propagation where X-ray beams diverge more over longer distances.

It should be noted that the illustration of the X-ray source 106 rotated to the right as shown in FIG. 1C is merely an example and should not limited the scope of the tomographic system 100 as described herein. Indeed, the X-ray source 106 can just as effectively be rotated to the left, dependent on specific requirements or configurations of the system. Alternatively or in addition, vertical angular adjustment can similarly be used without departing from this disclosure. The direction of the rotation is thus representative and no restrictive. For example, the angle θ can be set to 20 degrees when the X-ray source 106 is rotated in the opposite direction when the X-ray source 106 is positioned at a distance between 200 to 8 inches from the detector 102.

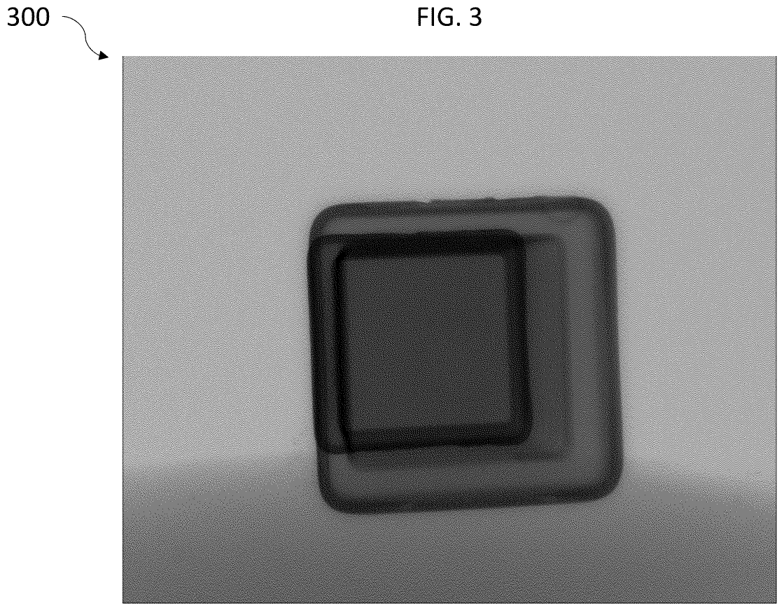

FIG. 3 is an example of an X-ray scan 300 obtained by the system and method as described herein, after the rotation of the X-ray source 106. As shown in FIG. 3, the X-ray scan 300 presents a clearer image where the effects or secondary radiation 204 have been removed sufficiently for the image to be used for analysis. That is, the capacitor appears with enhanced clarity compared to FIG. 2, as the bright spot at the center of the image has been sufficiently removed since the detector 102 no longer receives the secondary X-ray beam.

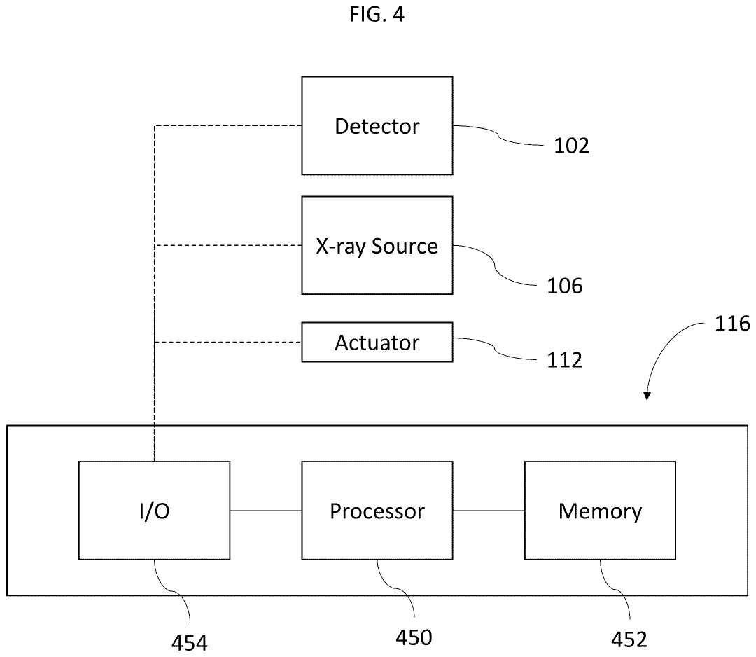

In some implementation, the tomographic imaging system 100 further includes at least one control unit 116 capable of executing one or more processing steps or any combinations thereof as described throughout this disclosure. FIG. 4 illustrates an example control unit 116 that can be used with some aspects of the current subject matter. The control unit 116 can, among other things, monitor parameters of the tomographic imaging system 100 and send signals to actuate and/or adjust various operating parameters of such systems. As shown in FIG. 4, the control unit 116 can include one or more processors 450 and non-transitory computer readable memory storage (e.g., memory 452) containing instructions that cause the processors 450 to perform operations. The processors 450 are coupled to an input/output (I/O) interface 450 for sending and receiving communications with components in the system, including, for example, the detector 102. In certain instances, the control unit 116 can additionally communicate status with and send actuation and/or control signals to one or more of the various system components (including, for example, the X-ray source 106 and/or the actuator 112) of the tomographic imaging system 100, as well as interface with one or more external networks for system updates, remote diagnostics, and data sharing.

The control unit 116 can be implemented with various levels of autonomy. In some implementations, the control unit 116 alerts the operator or technician that one or more parameters drift outside of predefined limits, for example, if an image artifact 204 is detected (based on the intensity of the image), the control unit 116 can issue an alert. The operator or technician then adjusts, through the I/O interfaces 450 such as dials, switches, touchscreen controls, or other direct input options, actuator parameters to re-align the X-ray source 106 relative to the detector 102. In some implementations, the control unit 116 alerts the operator or technician the parameters are out of specification and provides recommendations to the operator to move the parameters within specification. The operator then selects an option, and the control unit 116 adjusts operations as described herein accordingly. In some instances, the control unit 116 determines that a parameter is out of specification and changes or otherwise adjusts operations to move the parameter within specification with no input from the operator or technician.

In some implementations, the processor 450 can be equipped with software or algorithms implemented to execute pre-programmed movement pattern based on various imaging protocols and/or real-time condition inputs (e.g., detector signals or sensor data). The imaging protocols can be adjusted, for example, according to operational modes of the X-ray tube or the type of object 104 being imaged. In some implementations, the direction of the X-ray beams can be adjusted in accordance with the operation of the actuator as the detector 102 detects secondary X-ray beam 110. For example, if the secondary X-ray beam 110 is detected in at least a position of the detector 102, the processor 450 can automatically recalibrate the angle or position of the object support 113 and/or X-ray source 106 to eliminate or reduce the reference caused by the secondary X-ray beam 110.

In some instances, the processor 450 can receive data characterizing the position of the detector 102 and dynamically adjust the X-ray source-to-detector distance d and the offset distance of the object accordingly. In addition, the angle of rotation θ of the X-ray source 106 can also be adjusted according to the position of the detector 102. As described previously, the control unit 116 operably connected to the detector 102, the X-ray source 106, and the actuator 112, and continuously monitors the detector's position and other real-time conditions. For example, if the detector 102 is repositioned to accommodate changes in the imaging configuration or to focus on a specific area of the object 104, the control unit 116 can automatically recalibrate the system, without interrupting the imaging process, by adjusting the X-ray source-to-detector distance d and the offset distance of the object accordingly with no input from the operator or technician.

In some instances, the processor 450 can receive data characterizing the intensity of the secondary X-ray beam 110. The control unit 116, in response to fluctuations in the intensity of the secondary X-ray beam 110, can dynamically adjust the X-ray source-to detector distance d and the offset distance of the object to improve the image quality. For example, if the detector 102 registers an increase in the intensity of the secondary X-ray beam 110, or the processor 450 subsequently detects the intensity values of the pixels in the reconstructed image is out of bonds during the validation process, the control unit 116 can automatically recalibrate the tomographic imaging system 100 by increasing the distance between the X-ray source 106 and the detector 102 and/or the offset distance of the object. In addition, the control unit 116 can alter the angle of rotation of the X-ray source 106 to direct the secondary X-ray beam further away from the detector 102 with no input from the operator or technician.

Alternatively, or in addition, the tomographic imaging system 100 as described herein includes one or more sensors, such as optical sensors, proximity sensors, or motion sensors, communicatively connected to the control unit 116. These sensors continuously provide real-time data to the control unit 116 to monitor the position, movement, and orientation of the object 104. The processor 450 can, in certain implementations, receive data characterizing the position of the object 104 and adjust the operational parameters of the system accordingly. For example, if the object 104 shifts during imaging, the control unit 116 can dynamically adjust the position of the X-ray source 106, the angle of rotation θ, or the X-ray source-to-detector distance d to ensure that the primary X-ray beams 108 remain aligned with the object 104 and the detector 102, while the secondary X-ray beams 110 are directed away from the object 104 and the detector 102.

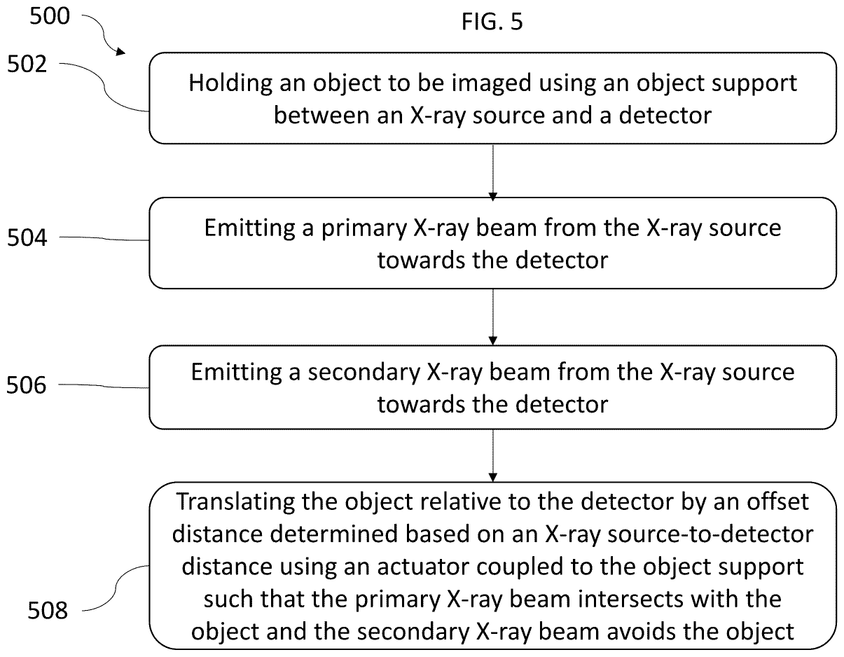

FIG. 5 is a flowchart of an example method 500 according to some example implementations. Aspects of the method 500 can be performed by the control unit 116 all or in part. At 502, the object to be imaged is held using the object support between the X-ray source and the X-ray detector.

At 504, the primary X-ray beam is emitted from the X-ray source towards the detector. The primary X-ray beam can be emitted using the electrical X-ray tube. The electrical X-ray tube includes an anode, and a cathode enclosed within a vacuum chamber. Such primary X-ray beam is produced by electrons emitted from cathode to the anode. In some implementations, the primary X-ray beam is characterized by a cone beam geometry with a divergent spread between the detector and the X-ray source. In some implementation, the electrical X-ray tube is configured to operate with an electron beam energy ranging from 40 keV to 9000 keV.

At 506, the secondary X-ray beam is emitted from the X-ray source towards the detector. Such secondary X-ray beam emission is caused by the backscattering of electrons from the anode within the electrical X-ray tube. The Secondary X-ray beam resulted from interactions between the backscattered electrons and the vacuum enclosure. In some implementation, the secondary X-ray beam is characterized by a quasi-parallel geometry with a truncated cylindrical shape. In some implementation, the secondary X-ray beam has a diameter of approximately 20 mm.

At 508, the object is translated relative to the detector by an offset distance determined based on the X-ray source-to-detector distance via the actuator coupled to the object support such that the primary X-ray beam intersects with the detector and the secondary X-ray beam avoids the detector. In some implementation, the actuator includes a motorized linear actuator configured to provide translational movement of the object support.

Alternatively, or in addition, data characterizing a position of the detector is received and a change in the position of the detector can be detected. In this scenario, the X-ray source-to-detector distance and the offset distance of the object are recalibrated based on the change in the position of the detector via the actuator. Such detection and configuration can be made by the control unit operably connected to the detector, the X-ray source, and the actuator. Further, data characterizing an intensity of the secondary X-ray beam can be received and a change in the intensity can be detected. In this scenario, the X-ray source-to-detector distance and the offset distance of the object are recalibrated based on the change in the intensity via the actuator.

While this disclosure contains many specific implementation details, these should not be construed as limitations on the scope of what may be claimed, but rather as descriptions of features specific to particular implementations of particular inventions. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described components and systems can generally be integrated together in a single product or packaged into multiple products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

. . . Other implementations can be within the scope of the following claims.

What is claimed:

1. A tomographic imaging system comprising:
a detector configured to receive X-ray beams;
an X-ray source arranged and configured to emit both a primary X-ray beam and a secondary X-ray beam towards the detector; and
an object support configured to hold an object to be imaged between the detector and the X-ray source; and
an actuator coupled to the object support and is configured to offset the object relative to a principal axis of the X-ray source by a distance determined based on an X-ray source-to-detector distance, such that the secondary X-ray beam is directed away from the object while the primary X-ray beam is aligned with the object.

2. The tomographic imaging system of claim 1, wherein the X-ray source comprises an electrical X-ray tube having an anode and a cathode enclosed within a vacuum chamber, wherein the cathode is configured to emit electrons towards the anode to emit the primary X-ray beam.

3. The tomographic imaging system of claim 2, wherein the secondary X-ray beam is emitted as a result of the electrons backscattering from the anode within the vacuum chamber.

4. The tomographic imaging system of claim 1, wherein the secondary X-ray beam is characterized by a cylindrical geometry between the detector and the X-ray source.

5. The tomographic imaging system of claim 4, wherein the secondary X-ray beam has a diameter of approximately 20 mm.

6. The tomographic imaging system of claim 1, wherein the primary X-ray beam is characterized by a cone beam geometry with a divergent spread between the detector and the X-ray source.

7. The tomographic aiming system of claim 2, wherein the electrical X-ray tube operates with an electron beam energy ranging from 40 keV to 9000 keV.

8. The tomographic imaging system of claim 1, wherein the actuator comprises a motorized linear actuator configured to provide a translational movement of the object support.

9. The tomographic imaging system of claim 1, further comprising a control unit operably connected to the detector, the X-ray source, and the actuator, wherein the control unit is configured to:
receive data characterizing a position of the detector; and
dynamically adjust, in response to a change in the position of the detector, the X-ray source-to-detector distance and the offset distance.

10. The tomographic imaging system of claim 9, wherein the control unit is further configured to:
receive data characterizing an intensity of the secondary X-ray beam; and
dynamically adjust, in response to a change in the intensity, the X-ray source-to-detector distance and the angle of rotation of the X-ray source.

11. A tomographic imaging system comprising:
a detector configured to receive X-rays;
an X-ray source arranged and configured to:
emit a primary X-ray beam having a first spread angle towards the detector; and
simultaneously emit a secondary X-ray beam having a second spread angle towards the detector, wherein the second spread angle is narrower than the first spread angle;
an object support configured to hold an object to be imaged between the detector and the X-ray source; and
an actuator coupled to the object support; and
a control unit operably connected to the detector, the X-ray source, and the actuator, wherein the control unit is configured to:
instruct the actuator to offset the object relative to a principal axis of the X-ray source by a distance determined based on an X-ray source-to-detector distance, such that the secondary X-ray beam is directed away from the object while the primary X-ray beam is aligned with the object;
receive data characterizing a position of the detector; and
dynamically adjust, in response to a change in the position of the detector, the X-ray source-to-detector distance and the offset distance.

12. A method comprising:
holding an object to be imaged using an object support between an X-ray source and a detector;
emitting a primary X-ray beam from the X-ray source towards the detector;
emitting a secondary X-ray beam from the X-ray source towards the detector; and
translating the object relative to the detector by an offset distance determined based on an X-ray source-to-detector distance using an actuator coupled to the object support such that the primary X-ray beam intersects with the object and the secondary X-ray beam avoids the object.

13. The method of claim 12, wherein emitting the primary X-ray beam comprises emitting, using an electrical X-ray tube having an anode and a cathode enclosed within a vacuum chamber, electrons from the cathode.

14. The method of claim 13, wherein emitting the secondary X-ray beam comprises unintentionally causing the electrons to backscatter from the anode to the cathode, and wherein the secondary X-ray beam results from interactions between the backscattered electrons and the vacuum enclosure.

15. The method of claim 12, wherein the secondary X-ray beam is characterized by a quasi-parallel geometry with a truncated cylindrical shape between the detector and the X-ray source that diverges from the primary X-ray beam.

16. The method of claim 15, wherein the secondary X-ray beam has a diameter of approximately 20 mm.

17. The method of claim 12, wherein the primary X-ray beam is characterized by a cone beam geometry with a divergent spread between the detector and the X-ray source.

18. The method of claim 12, wherein the electrical X-ray tube operates with an electron beam energy ranging from 40 keV to 9000 keV.

19. The method of claim 12, wherein the actuator comprises a motorized linear actuator configured to provide a translational movement of the object support.

20. The method of claim 12, further comprising:
receiving data characterizing a position of the detector; and
dynamically adjusting, in response to a change in the position of the detector, the offset distance.

21. The method of claim 12, further comprising:
receiving data characterizing an intensity of the secondary X-ray beam; and
dynamically adjusting, in response to a change in the intensity, the offset distance.
